(19) United States
(12) Patent Application Publication
(10) Pub. No.: US 2007/0097386 A1
(43) Pub. Date: May 3, 2007

(54) Imaging system and method

(76) Inventors: Michael A. Tregoning, Greeley, CO (US); Meing Fai Nigel Cheung, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,482

(22) Filed: Oct. 31, 2005

(51) Int. Cl. H04N 1/00

(52) U.S. Cl. 358/1.6; 358/509

(57) ABSTRACT

An imaging system comprising a scanning device having a fluorescent lamp and a secondary light source for illuminating a media object to be scanned, the secondary light source configured to emit light at a different frequency spectrum than the fluorescent lamp, a scanned image of the media object generated using image data obtained from at least one scan of the media object using light emitted by the fluorescent lamp and the secondary light source.

### BACKGROUND OF THE INVENTION

Scanning devices typically use a fluorescent lamp (e.g., a cold cathode fluorescent lamp (CCFL)) to illuminate a media object during a scanning operation. However, such fluorescent lamps emit light having spectrum peaks at particular frequencies or frequency ranges. Software is used to compensate for image colors in a media object falling outside the peak frequency ranges of the fluorescent lamp. However, increasingly subtle colors in the media object falling outside the peak frequency ranges are particular difficult for such software products to accurately reproduce.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of an imaging system in accordance with the present invention; and

FIG. 2 is a diagram illustrating an exemplary spectral response of the imaging system of FIG. 1.

### DETAILED DESCRIPTION OF THE DRAWINGS

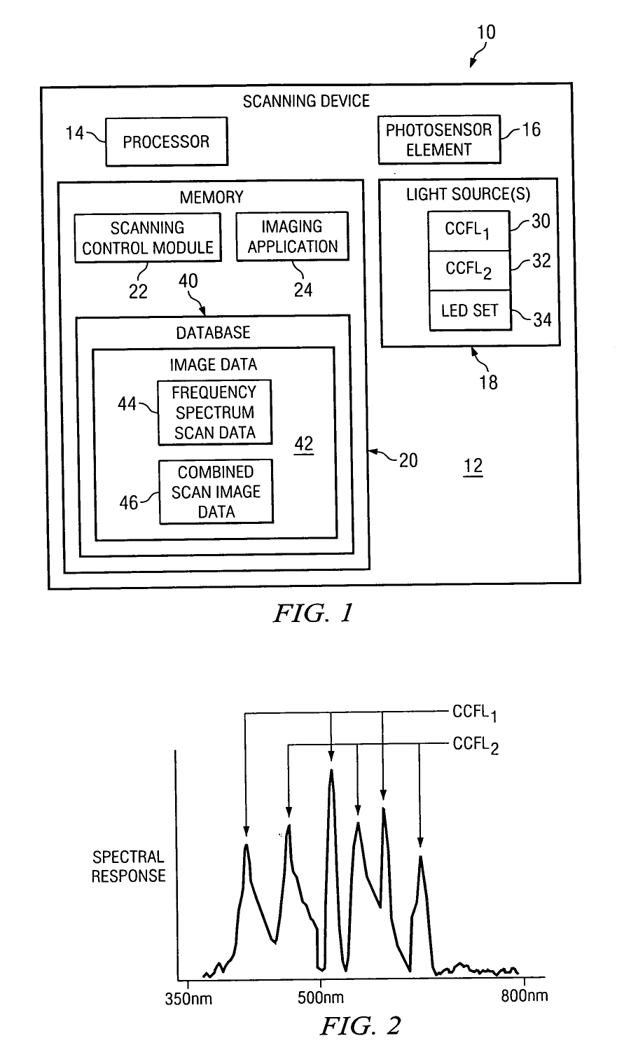

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of an imaging system 10 in accordance with the present invention. In the embodiment illustrated in FIG. 1, system 10 comprises a scanning device 12 having a processor 14, a photosensor element 16 and a plurality of different light sources 18. Scanning device 12 may comprise any type of device for generating a scanned image of a media object such as, but not limited to, a scanner, facsimile machine or copier. Photosensor element 16 may comprise any type of device for generating electrical signals from optical signals such as, but nor limited to, a charge-coupled device (CCD). It should be understood that embodiments of the present invention may be used in both reflective and transmissive scanning applications.

In the embodiment illustrated in FIG. 1, scanning device 12 also comprises a memory 20 having a scanning control module 22 and an imaging application 24. Scanning control module 22 and imaging application 24 may comprise hardware, software, or a combination of hardware and software. In FIG. 1, scanning control module 22 and imaging application 24 are illustrated as being disposed in memory 20 so as to be accessible and/or executable by processor 14. However, it should be understood that scanning control module 22 and/or imaging application 24 may be otherwise stored, even remote from scanning device 12. Scanning control module 22 is used to activate/de-activate light sources 18 for scanning and/or otherwise illuminating a media object to be scanned. Imaging application 24 is used, in some embodiments of the present invention, to generate a scanned image of the media object using image data obtained from a plurality of scans of the media object.

In the embodiment illustrated in FIG. 1, light sources 18 are each preferably configured having different spectral response frequency characteristics to produce enhanced color information in the scanned image of the media object. For example, in the embodiment illustrated in FIG. 1, light sources 18 comprise a cold cathode fluorescent lamp (CCFL₁) 30, a CCFL₂ 32 and a light emitting diode (LED) set 34. It should be understood that additional types of light sources may also be used. Embodiments of the present invention may be configured having a variety of different light source 18 combinations to produce different spectral response frequency characteristics for a scanned image of the media object. For example, in one embodiment of the present invention, scanning device 12 is configured having a primary light source 18 with predetermined spectral response characteristics and a secondary light source 18 having different spectral response characteristics than the primary light source 18. As used herein, “primary” and “secondary” are used to differentiate between different light sources 18 and not to designate a preferred light source 18. It should also be understood that “secondary” does not otherwise limit scanner device 12 to only two light sources 18 as it should be understood that three or more light sources 18 may also be used.

Embodiments of the present invention utilize a cold cathode fluorescent lamp (e.g., CCFL₁ 30) in combination with another cold cathode fluorescent lamp (e.g., CCFL₂ 32) and/or at least one LED set 34 to emit light having different spectral response characteristics to generate a scanned image of a media object having enhanced color characteristics. As used herein, a “set” may comprise a single LED or multiple LEDs. Preferably, each LED of set 34 is selected having a spectral response characteristic different than the spectral response characteristics of the selected fluorescent lamps (e.g., lamps 30 and/or 32).

For example, in one embodiment of the invention, scanning device 12 is configured having a single CCFL₁ 30 and LED set 34 where one or more LEDS of LED set 34 each have a different spectral response characteristic than CCFL₁ 30. Thus, the LED set 34 is used to provide a shifted spectral response relative to the response of CCFL₁ 30, thereby providing broader color spectrum response for the optimized scanned image. In another embodiment of the present invention, scanning device 12 is configured having CCFL, 30 and CCFL₂ 32, where CCFL₂ 32 is configured having a different spectral response frequency characteristic than CCFL₁ 30. Preferably, different phosphor mixtures and/or coatings are used to create different spectral response characteristics for each of CCFL₁ 30 and CCFL₂ 32. However, it should be understood that other methods may be used to produce light sources 18 having different spectral response characteristics. Thus, for example, CCFL₂ 32 is preferably configured having spectral response characteristics that are shifted relative to the spectral response characteristic of CCFL, 30 such that a broader color spectrum is obtained for a scanned image of the media object. In yet another embodiment of the present invention, scanning device 12 is configured having CCFL₁ 30, CCFL₂ 32 and LED set 34 each having different spectral response frequency characteristics. Accordingly, it should be understood that a variety of combinations of light sources 18 may be used to obtain broader color spectrum coverage (e.g., CCFL₁ 30 and CCFL₂ 32; CCFL₁ 30 and LED set 34; CCFL₂ 32 and LED set 34; or CCFL₁ 30, CCFL₂ 32 and LED set 34).

In operation, scanning device 12 generates a scanned image of a media object by illuminating the media object with at least two different light sources 18 where each light source 18 has a different spectral response characteristic, thereby providing enhanced color characteristics for the scanned image. The light sources 18 are selected such that each light source 18 “fills” the spectral response gaps of another selected light source 18. In some embodiments of the present invention, scanning device 12 is configured to use a single light source 18 for general scanning operations and use multiple light sources 18 for scanning operations where an enhanced color scanned image is desired (e.g., in response to a user input request for an enhanced color scanned image or otherwise). However, it should be understood that scanning device 12 may be configured to automatically use multiple light sources 18 as a default scanning mode. It should be understood that scanning device 12 may also be configured having different levels of color enhancement where different and/or additional light sources 18 are used for each different level of enhanced color (e.g., CCFL, 30 for a general scanning mode; CCFL₁ 30 and CCFL₂ 32 for an enhanced color scanning mode; and CCFL₁ 30, CCFL₂ 32 and LED set 34 for a further enhanced color scanning mode). Thus, based on a selected scanning mode, control module 22 controls activation of the corresponding light sources 18 for the selected scanning mode.

In the embodiment illustrated in FIG. 1, memory 20 comprises a database 40 having image data 42. Image data 42 comprises information associated with scanned images of a media object using one or more light sources 18. For example, in the embodiment illustrated in FIG. 1, image data 42 comprises frequency spectrum scan data 44 and combined scan image data 46. Frequency spectrum scan data 44 comprises information associated with one or more scans of a particular media object using one or more different light sources 18, concurrently or alternately. For example, in some embodiments of the present invention, a scanned image of a media object is obtained by illuminating one of light sources 18 (e.g., CCFL₁ 30) during a first scanning pass of the media object, and illuminating another light source 18 (e.g., CCFL₂ 32 and/or LED set 34) during a second scanning pass of the media object. The scanned image information obtained during each scanning pass is stored as frequency spectrum scan data 44. It should be understood that, alternatively, light sources 18 may be alternately illuminated at each scan line instead of entire pass scanning. In the above example, each scan of the media object using a different light source 18 is combined to form a color-enhanced scanned image of the media object, represented in FIG. 1 as combined scan image data 46. For example, in some embodiments of the present invention, imaging application 24 is configured to overlay each of the scanned images obtained using a different light source 18 to generate the color-enhanced scanned image 46 of the media object. However, it should be understood that imaging application 24 may be configured to generate the scanned image 46 of the media object using a variety of different methods (e.g., merging, blending and/or otherwise manipulating the scanned image data).

It should be understood that in some embodiments of the present invention, multiple light sources 18 are activated concurrently by control module 20 during a single scanning pass to generate a color-enhanced scanned image of a particular media object. In this example, a single scan of the media object provides a color-enhanced scanned image of the media object without further post-scan processing (e.g., without having to combine multiple scanned images of the media object).

Thus, in operation, scanning control module 22 controls activation and de-activation of light sources 18 for a particular scan of a media object. As described above, multiple light sources 18 may be activated concurrently or alternately to generate one or more scanned images of a media object. The different light sources 18 used to illuminate the media object for each scan thereby produce different spectral response characteristics to form and/or otherwise produce enhanced color of the scanned image over a visible frequency spectrum.

FIG. 2 is a diagram illustrating spectral response characteristics of system 10. For example, in FIG. 2, CCFL₁ 30 may be configured having spectral response characteristics with peaks at approximately 430 nanometers (e.g., blue), 546 nanometers (e.g., green) and 612 nanometers (e.g., red). Other light sources 18 of scanning device 12 are preferably configured having spectral response characteristics different than the spectral peaks illustrated in FIG. 2 for CCFL₁ 30 to obtain enhanced or broader color information across the visible spectrum. For example, in some embodiments of the present invention, CCFL₂ 32 is configured having spectral response characteristics such that spectral peaks of CCFL₂ 32 are located at approximately 452 nanometers, 575 nanometers, and 635 nanometers. It should be understood that the particular spectral peaks of each of light sources 18 may be otherwise configured. In FIG. 2, CCFL₁ 30 and CCFL₂ 32 are illustrated each generally having three spectral peaks. However, it should be understood that each selected light source 18 may have a greater or lesser quantity of spectral peaks. For example, in addition to the spectral peaks illustrated in FIG. 2 associated with CCFL, 30 and CCFL₂ 32, an LED set 34 may be combined therewith to provide one or more additional spectral peaks (e.g., a single LED for an additional spectral peak at a predetermined frequency or multiple LEDs for multiple additional spectral peaks at predetermined spectral frequencies).

Thus, embodiments of the present invention use different light sources 18 configured having different spectral response characteristics to provide additional color information in different spectral regions. As described above, the image information obtained from scanning a media object with at least two different light sources 18 each having different spectral response characteristics is used to generate a scanned image of the media object having enhanced color characteristics.

What is claimed is:

1. An imaging system, comprising:
a scanning device having a fluorescent lamp and a secondary light source for illuminating a media object to be scanned, the secondary light source configured to emit light at a different frequency spectrum than the fluorescent lamp, a scanned image of the media object generated using image data obtained from at least one scan of the media object using light emitted by the fluorescent lamp and the secondary light source.

2. The system of claim 1, further comprising an imaging application configured to generate the scanned image from at least two different scans of the media object.

3. The system of claim 1, wherein the secondary light source comprises a fluorescent lamp.

4. The system of claim 1, wherein the secondary light source comprises at least one light emitting diode.

5. The system of claim 1, further comprising a scanning control module configured to concurrently activate the fluorescent lamp and the secondary light source to generate the scanned image of the media object.

6. The system of claim 1, further comprising a scanning control module configured to alternately activate the fluorescent lamp and the secondary light source to generate at least two different scans of the media object.

7. The system of claim 6, further comprising an imaging application configured to using the at least two different scans to generate the scanned image.

8. The system of claim 1, further comprising a scanning control module configured to control activation of the fluorescent lamp and the secondary light source based on a selected scanning mode.

9. An imaging method, comprising:
activating a fluorescent lamp and a secondary light source of a scanning device to illuminate a media object to be scanned, the secondary light source configured to emit light at a different frequency spectrum than the fluorescent lamp; and
generating a scanned image of the media object using image data obtained from at least one scan of the media object using light emitted by the fluorescent lamp and the secondary light source.

10. The method of claim 9, wherein activating the secondary light source comprises activating another fluorescent lamp.

11. The method of claim 9, wherein activating the secondary light source comprises activating at least one light emitting diode.

12. The method of claim 9, wherein activating the fluorescent lamp and the secondary light source comprises concurrently activating the fluorescent lamp and the secondary light source.

13. The method of claim 9, wherein activating the fluorescent lamp and the secondary light source comprises alternately activating the fluorescent lamp and the secondary light source to generate at least two different scans of the media object.

14. The method of claim 13, further comprising using the at least two different scans of the media object to generate the scanned image.

15. The method of claim 9, further comprising controlling activation of the fluorescent lamp and the secondary light source based on a selected scanning mode.

16. A method for manufacturing a scanning device, comprising:
providing a fluorescent lamp and a secondary light source for illuminating a media object to be scanned, the secondary light source configured to emit light at a different frequency spectrum than the fluorescent lamp, and for generating a scanned image of the media object generated using image data obtained from at least one scan of the media object using light emitted by the fluorescent lamp and the secondary light source.

17. The method of claim 16, wherein providing the secondary light source comprises providing another fluorescent lamp.

18. The method of claim 16, wherein providing the secondary light source comprises providing at least one light emitting diode.

19. The method of claim 16, further comprising providing a scanning control module configured to concurrently activate the fluorescent lamp and the secondary light source to generate the scanned image of the media object.

20. The method of claim 16, further comprising providing a scanning control module configured to alternately activate the fluorescent lamp and the secondary light source for at least two scans of the media object.

21. The method of claim 20, further comprising providing an imaging application configured to use image data obtained from the at least two scans of the media object to generate the scanned image of the media object.

22. The method of claim 16, further comprising providing a scanning control module configured to control activation of the fluorescent lamp and the secondary light source based on a selected scanning mode.

23. An imaging system, comprising:
fluorescent lamp means disposed in a scanning device for illuminating a media object to be scanned;
a secondary light means disposed in the scanning device for illuminating the media object to be scanned, the secondary light means configured to emit light at a different frequency spectrum than the fluorescent lamp means, a scanned image of the media object generated using image data obtained from at least one scan of the media object using light emitted by the fluorescent lamp means and the secondary light means.

24. The system of claim 23, further comprising means for concurrently activating the fluorescent lamp means and the secondary light means for generating the scanned image of the media object.

25. The system of claim 23, further comprising means for alternately activating the fluorescent lamp means and the secondary light means for generating at least two different scans of the media object.

26. The system of claim 25, further comprising means for using the at least two different scans to generate the scanned image.
